(19) United States
(12) Patent Application Publication
(10) Pub. No.: US 2022/0301023 A1
(43) Pub. Date: Sep. 22, 2022

(54) IMPACTFUL PARAMETER DETERMINATION FOR BRAND ENHANCEMENT

(71) Applicant: Honda Motor Co., Ltd., Tokyo (JP)

(72) Inventor: Ting Zhang, Torrance, CA (US)

(21) Appl. No.: 17/208,960

(22) Filed: Mar. 22, 2021

(51) Int. Cl. G06Q 30/02

(52) U.S. Cl. CPC G06Q 30/0282; G06Q 30/0203

(57) ABSTRACT

An electronic device and a method for impactful parameter determination for brand enhancement is provided. The electronic device receives a plurality of responses for a plurality of questions associated with one or more surveys related to one or more services provided by an organization. The electronic device further determines a first set of responses for a first set of questions from the received plurality of responses. The electronic device further calculates an attribution score for each of the first set of parameters based on the determined first set of responses. The electronic device further determines a first parameter from the first set of parameters based on the calculated attribution scores. The determined first parameter, among the first set of parameters, has a maximum impact on a brand associated with the one or more services. The electronic device further controls a first service associated with the determined first parameter.

### BACKGROUND

With the advancement in data processing technologies, various types of surveys are conducted by an organization to obtain various kinds of insights and/or feedbacks about products or services provided by the organization. One such insight is a net promoter score (NPS) of the organization. The NPS is an index that may measure a willingness of customers to recommend an organization's products or services to other people. The NPS can be used as a proxy to gauge the customer's overall satisfaction with the organization's products or services, and to gauge customer's loyalty towards a brand. However, the customer's willingness to recommend the organization's product or service or the customer's overall satisfaction may be dependent upon various parameters related to the products or services. Some of the parameters may be subjective and may be dependent upon a customer's liking (such as an affinity towards a product's application interface or towards the related functionality), and some of the parameters may be purely associated with the organization. In certain situations, certain parameters do not contribute much towards the improvement of the NPS or sometimes the organization is not aware about important parameters which may lead to a significant improvement in the overall NPS of the organization.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, an electronic device for impactful parameter determination for brand enhancement is provided. The electronic device may include circuitry. The circuitry may be configured to receive a plurality of responses for a plurality of questions that may be associated with one or more surveys. The one or more surveys may be related to one or more services provided by an organization. The circuitry may be further configured to determine a first set of responses for a first set of questions from the received plurality of responses. The first set of questions may be associated with a first set of parameters of a set of service categories related to the one or more services. The circuitry may be further configured to calculate an attribution score for each of the first set of parameters based on the determined first set of responses. The attribution score may indicate an impact of the corresponding parameter on a brand associated with the one or more services. The circuitry may be further configured to determine a first parameter from the first set of parameters based on the calculated attribution scores. The determined first parameter, among the first set of parameters, may have a maximum impact on the brand. The circuitry may be further configured to control a first service associated with the determined first parameter.

According to another embodiment of the disclosure, a method for impactful parameter determination for brand enhancement is provided. The method may include receiving a plurality of responses for a plurality of questions that may be associated with one or more surveys. The one or more surveys may be related to one or more services provided by an organization. The method may include determining a first set of responses for a first set of questions from the received plurality of responses. The first set of questions may be associated with a first set of parameters of a set of service categories related to the one or more services. The method may further include calculating an attribution score for each of the first set of parameters based on the determined first set of responses. The attribution score may indicate an impact of the corresponding parameter on a brand associated with the one or more services. The method may further include determining a first parameter from the first set of parameters based on the calculated attribution scores. The determined first parameter, among the first set of parameters, may have a maximum impact on the brand. The method may further include controlling a first service associated with the determined first parameter.

According to another embodiment of the disclosure, a non-transitory computer-readable medium is provided. The non-transitory computer-readable medium may have stored thereon computer implemented instructions that, when executed by a computer, causes the computer to execute operations. The operations may include receiving a plurality of responses for a plurality of questions that may be associated with one or more surveys. The one or more surveys may be related to one or more services provided by an organization. The operations may include determining a first set of responses for a first set of questions from the received plurality of responses. The first set of questions may be associated with a first set of parameters of a set of service categories related to the one or more services. The operations may further include calculating an attribution score for each of the first set of parameters based on the determined first set of responses. The attribution score may indicate an impact of the corresponding parameter on a brand associated with the one or more services. The operations may further include determining a first parameter from the first set of parameters based on the calculated attribution scores. The determined first parameter, among the first set of parameters, may have a maximum impact on the brand. The operations may further include controlling a first service associated with the determined first parameter

### BRIEF DESCRIPTION OF THE DRAWINGS

FIG. 1 is a block diagram that illustrates an exemplary network environment for impactful parameter determination for brand enhancement, in accordance with an embodiment of the disclosure.

FIG. 2 is a block diagram that illustrates an exemplary electronic device for impactful parameter determination for brand enhancement, in accordance with an embodiment of the disclosure.

FIG. 3 is a diagram that illustrates exemplary operations for impactful parameter determination for brand enhancement, in accordance with an embodiment of the disclosure.

FIG. 4A depicts an exemplary set of responses for a plurality of questions in one or more surveys related to a vehicle brand, in accordance with an embodiment of the disclosure.

FIG. 4B depicts an exemplary attribution scores for each parameter related to the vehicle brand of FIG. 4A, in accordance with an embodiment of the disclosure.

FIG. 5 depicts an exemplary normalized attribution score and attribution percentage of each parameter related to the vehicle brand, in accordance with an embodiment of the disclosure.

FIG. 6 is a flowchart that illustrates exemplary operations for impactful parameter determination for brand enhancement, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed electronic device for impactful parameter determination for brand enhancement. Exemplary aspects of the disclosure may provide an electronic device that may be configured to receive a plurality of responses (i.e. a plurality of answers or ratings) for a plurality of questions (i.e. a plurality of queries) that may be associated with one or more surveys (for example, but is not limited to, a brand awareness survey, a feedback survey, or a survey related to a product/service). The surveys may be related to one or more services (for example, but is not limited to, a vehicle related service, a finance service, a product related service, a maintenance service, a troubleshooting service, etc.) provided by an organization. The electronic device may be further configured to determine a first set of responses for a first set of questions from the received plurality of responses. The first set of questions may be associated with a first set of parameters (i.e. episodes) of a set of service categories (for example, but is not limited to, a dealer-related category, a customer experience-related category, an ambience-related category, a sales-related category, a functionality-related category, etc.) related to the one or more services provided by the organization. The electronic device may be further configured to calculate an attribution score for each of the first set of parameters based on the determined first set of responses. The attribution score may indicate an impact of the corresponding parameter on a brand associated with the one or more services. The electronic device may be further configured to determine a first parameter from the first set of parameters based on the calculated attribution scores, where the determined first parameter may have a maximum impact on the brand among the first set of parameters. The electronic device may be further configured to control a first service associated with the determined first parameter.

The disclosed electronic device may be able to determine the first parameter that may have maximum impact on the brand (or a brand rating value) of the organization and further control execution of one or more operations related to the first service. The one or more operations may be executed for an improvement of the first service (i.e. related to the determined impactful first parameter) to further enhance the brand of the organization. As an example, the one or more operations may include a recommendation for a training session for one or more dealer employees to assist customers. As another example, the one or more operations may include recommendation for upgradation of the infrastructure at the dealerships to reduce waiting time for the customers. The improvement of the first service (i.e. for example dealership) may increase the brand rating value of the brand of the organization which may further lead to increase in sales as well as reputation of the brand as a whole in future. Therefore, determination of the most impactful parameter by the disclosed electronic device, based on the analysis of the first set of survey responses and control of the operations of the first service (i.e. associated with the impactful or critical parameter) may provide enhancement to the brand (or enhancement to the overall NPS score) of the organization and associated services.

Reference will now be made in detail to specific aspects or features, examples of which are illustrated in the accompanying drawings. Wherever possible, corresponding or similar reference numbers will be used throughout the drawings to refer to the same or corresponding parts.

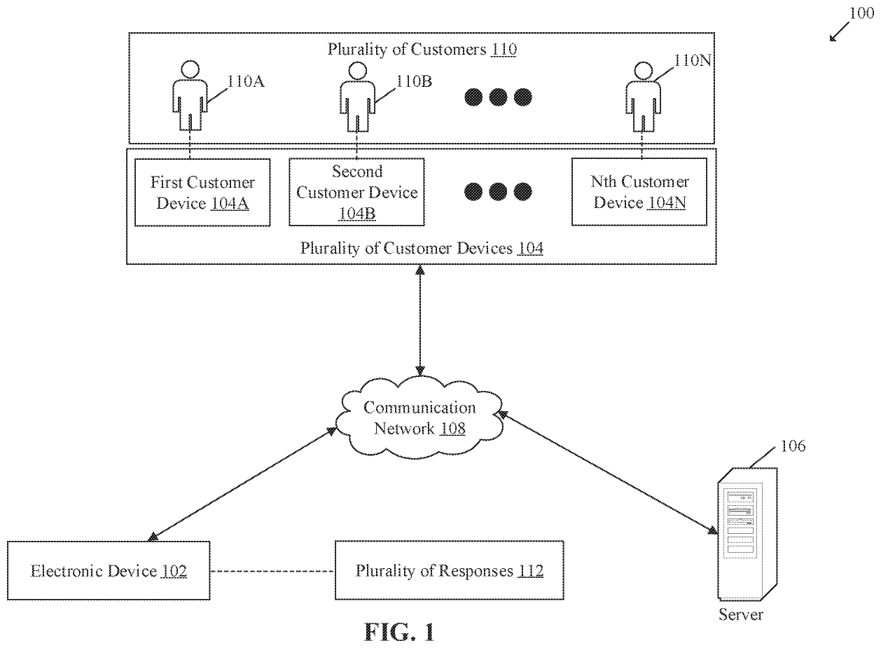

FIG. 1 is a block diagram that illustrates an exemplary network environment for impactful parameter determination for brand enhancement, in accordance with an embodiment of the disclosure. With reference to FIG. 1, there is shown a network environment diagram 100 which may include an electronic device 102. In FIG. 1, there is further shown a plurality of customer devices 104, a server 106 and a communication network 108. The plurality of customer devices 104 may be associated a plurality of customers 110 and may include a first customer device 104A, a second customer device 104B, and up to an Nth customer device 104N. The first customer device 104A may be associated with a first customer 110A, the second customer device 104B may be associated with a second customer 110B. Similarly, the Nth customer device 104N may be associated with an Nth customer 110N. Further, in FIG. 1, there is also shown a plurality of responses 112 that may be provide by the plurality of customers 110 in one or more surveys.

The electronic device 102 may include suitable logic, circuitry, interfaces, and/or code that may be configured to receive the plurality of responses 112 for a plurality of questions asked in one or more surveys. The electronic device 102 may be configured to determine a parameter from a first set of parameters that may have a maximum impact on a brand associated with one or more services that may be provided by an organization. Examples of the electronic device 102 may include, but are not limited to, a computing device, a smartphone, a cellular phone, a mobile phone, a mainframe machine, a server (such as the server 106), a computer workstation, and/or a consumer electronic (CE) device. In an embodiment, the electronic device 102 may be associated with the organization. In other embodiments, the electronic device 102 may be associated with a seller or a dealer of equipment/services provided by the organization. In another embodiment, the electronic device 102 may be associated with a marketing team of the organization to enhance the brand of the organization.

Each of the plurality of customer devices 104 may include suitable logic, circuitry, and interfaces that may be configured to transmit at least one response for the plurality of questions to the electronic device 102. The plurality of customer devices 104 may be configured to display the plurality of questions of a particular survey to the plurality of customers 110 and receive the plurality of responses 112 from the plurality of customers 110. Examples of each of the plurality of customer devices 104 may include, but are not limited to, a computing device, a smartphone, a cellular phone, a mobile phone, a gaming device, a mainframe machine, a server, a computer work-station, and/or a consumer electronic (CE) device.

The server 106 may include suitable logic, circuitry, and interfaces, and/or code that may be configured to store the received plurality of responses 112. The server 106 may be further configured to store the plurality of questions associated with one or more surveys. In an embodiment, the server 106 may host a website (i.e. associated with the organization) for the one or more surveys. In some embodiments, the plurality of responses 112 may be provided by the plurality of customers 110 to the server 106, and further the electronic device 102 may retrieve the stored plurality of responses 112 from the server 106. The server 106 may be implemented as a cloud server and may execute operations through web applications, cloud applications, HTTP requests, repository operations, file transfer, and the like. Other example implementations of the server 106 may include, but are not limited to, a database server, a file server, a web server, a media server, an application server, a mainframe server, or a cloud computing server.

In at least one embodiment, the server 106 may be implemented as a plurality of distributed cloud-based resources by use of several technologies that are well known to those ordinarily skilled in the art. The implementation of the server 106 and the electronic device 102 as two separate entities. In certain embodiments, the functionalities of the server 106 can be incorporated in its entirety or at least partially in the electronic device 102, without a departure from the scope of the disclosure.

The communication network 108 may include a communication medium through which the electronic device 102, the plurality of customer devices 104, and the server 106 may communicate with each other. The communication network 108 may be one of a wired connection or a wireless connection. Examples of the communication network 108 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in FIG. 1 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the one or more surveys may be conducted for the one or more services provided by the organization. In an embodiment, the one or more surveys may be conducted by the organization for the one or more services/products provided to the plurality of customers 110. In another embodiment, the one or more surveys may be conducted by a third-party corporation for the one or more services provided by the organization. The one or more surveys may measure awareness of the organization in a market and may also provide detailed analysis of consumer's viewpoint about the organization or about the services provided by the organization. The one or more surveys may be conducted on an audience that may also include the plurality of customers 110. The one or more surveys may be conducted in either a questionnaire form or an interview form and may include the plurality of questions related to the one or more services provided by the organization. Specifically, the one or more surveys may include a set of questions associated with a set of parameters (i.e. episodes) of a set of service categories (i.e. episodes categories) related to the one or more services. The set of service categories may correspond to at least one of, but is not limited to, a dealer-related category, a customer experience-related category, an ambience-related category, a troubleshooting-related category, a sales-related category, a finance-related category, a price-related category, a product-related category, a functionality-related category, an aesthetics-related category, or a hospitality-related-category. In other words, different service categories include different types of services provided by the organization to the plurality of customers 110. In an embodiment, the one or more surveys may also include a question associated with the brand (or a brand rating value) of the organization.

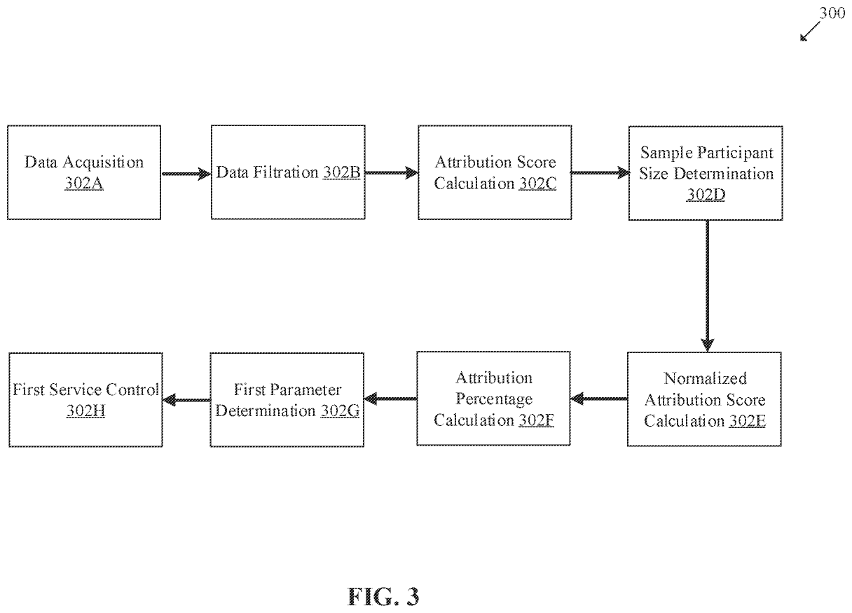

The electronic device 102 may receive the plurality of responses 112 for the plurality of questions asked in the one or more surveys. Each of the plurality of responses 112 may include a rating value for a corresponding question of the plurality of questions. In an embodiment, the rating value for each of the plurality of questions may be between a minimum rating value (for example “0”) and a maximum rating value (for example “10”). Based on the reception of the plurality of responses, the electronic device 102 may be further configured to determine a first set of responses for a first set of questions from the received plurality of responses. The first set of questions may be associated with a first set of parameters of the set of service categories related to the one or more services. The details about the first set of parameters are provided, for example, in FIG. 3.

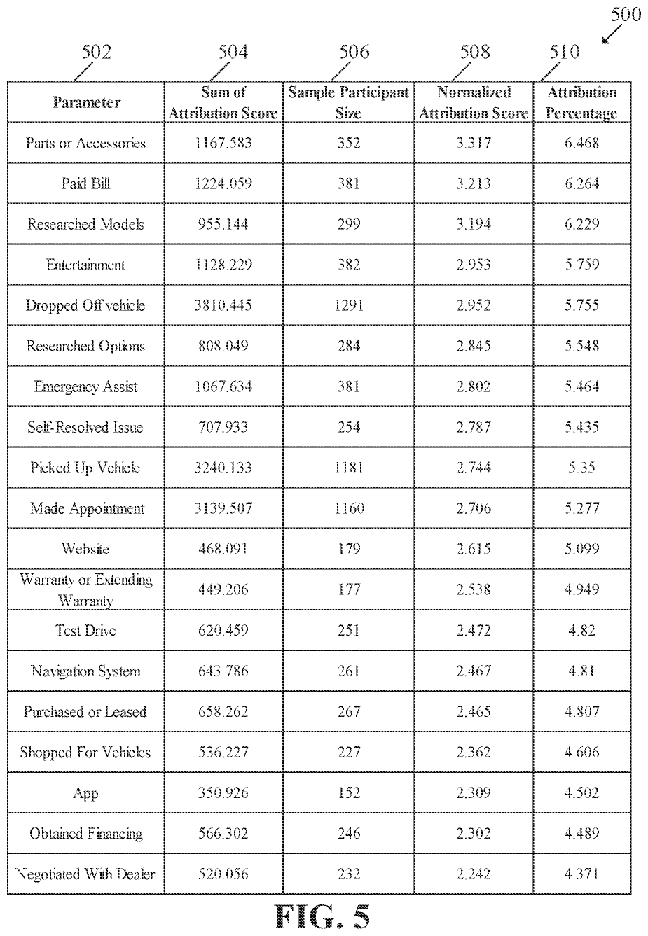

The electronic device 102 may further calculate an attribution score for each of the first set of parameters based on the determined first set of responses. The attribution score of a parameter may indicate an impact of the corresponding parameter on the brand associated with the one or more services. The electronic device 102 may further determine a first parameter from the first set of parameters based on the calculated attribution score of each of the first set of parameters. The determined first parameter, among the first set of parameters, may have a maximum impact on the brand (or the brand rating value). The details about the calculation of the attribution score and the determination of the first parameter are provided, for example, in FIGS. 3, 4A-4B, and 5. Based on the determination of the first parameter, the electronic device 102 may be configured to control a first service associated with the determined first parameter. The control of the first service may correspond to an execution of one or more operations related to the first service that may increase the brand rating value of the brand associated with the organization. The control of the first service related to the determined first parameter (i.e. most impactful parameter) is further described, for example, in FIGS. 3 and 5.

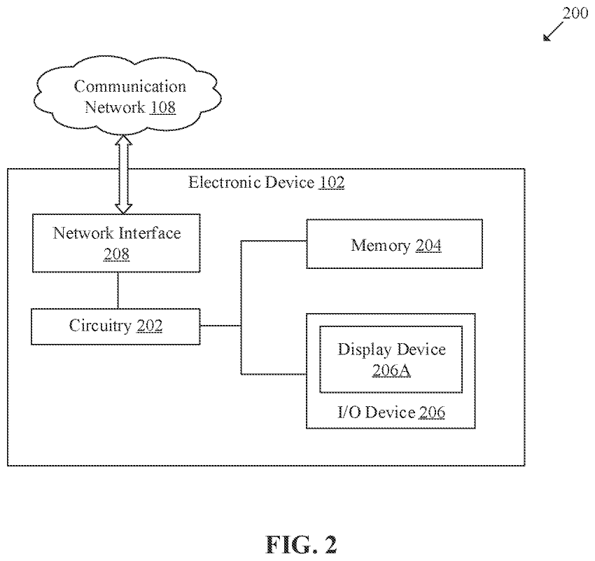

FIG. 2 is a block diagram that illustrates an exemplary electronic device for impactful parameter determination for brand enhancement, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202, a memory 204, an input/output (I/O) device 206 and a network interface 208. The circuitry 202 may be connected to the memory 204, the I/O device 206 and the network interface 208 through wired or wireless connections. Although in FIG. 2, it is shown that the electronic device 102 includes the circuitry 202, the memory 204, the I/O device 206 and the network interface 208; however, the disclosure may not be so limiting and the electronic device 102 may include less or more components to perform the same or other functions of the electronic device 102. Details of the other functions have been omitted from the disclosure for the sake of brevity.

The circuitry 202 may include suitable logic, circuitry, interfaces, and/or code that may be configured to execute a set of operations which may include, determination of the first set of responses, calculation of the attribution score, determination of the first parameter, and control of the first service associated with the determined first parameter. The circuitry 202 may include any suitable special-purpose or general-purpose computer, computing entity, or processing device including various computer hardware or software modules and may be configured to execute instructions stored on any applicable computer-readable storage media. For example, the circuitry 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The circuitry 202 may include any number of processors configured to, individually or collectively, perform or direct performance of any number of operations of the electronic device 102, as described in the present disclosure. Examples of the circuitry 202 may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 204 may include suitable logic, circuitry, interfaces, and/or code that may be configured to store the set of instructions executable by the circuitry 202. The memory 204 may be configured to store the received plurality of responses 112. The memory 204 may be further configured to store a plurality of instructions for calculation of the attribution score, a normalized attribution score, and an attribution percentage for each of the first set of parameters. Examples of implementation of the memory 204 may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to may receive inputs (such as the plurality of responses 112) from the plurality of customers 110, and provide output (such as the determined first parameter). The I/O device 206 may include one or more input and output devices that may communicate with different components of the electronic device 102. Examples of the I/O device 206 may include, but are not limited to, a touch screen, a keyboard, a mouse, a joystick, a microphone, a speaker, and a display device (such as the display device 206A).

The display device 206A may include suitable logic, circuitry, and interfaces that may be configured to display the determined first parameter and one or more operations to be executed by the electronic device 102. In some embodiments, the display device 206A may output the plurality of questions for the plurality of customers 110 to provide the plurality of responses 112. The display device 206A may be a touch screen which may enable a user of the electronic device 102 to provide a user-input (such as a response to a survey question) via the display device 206A. The touch screen may be at least one of a resistive touch screen, a capacitive touch screen, or a thermal touch screen. The display device 206A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 206A may refer to a display screen of a head mounted device (HMD), a smart-glass device, a see-through display, a projection-based display, an electro-chromic display, or a transparent display.

The network interface 208 may include suitable logic, circuitry, and interfaces that may be configured to facilitate communication between the circuitry 202, the plurality of customer devices 104, and the server 106, via the communication network 108. The network interface 208 may be implemented by use of various known technologies to support wired or wireless communication of the electronic device 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS). The functions or operations executed by the electronic device 102, as described in FIG. 1, may be performed by the circuitry 202. Operations executed by the circuitry 202 are described in detail, for example, in the FIGS. 3, 4A, 4B, 5 and 6.

FIG. 3 is a diagram that illustrates exemplary operations for impactful parameter determination for brand enhancement, in accordance with an embodiment of the disclosure. FIG. 3 is explained in conjunction with elements from FIG. 1 and FIG. 2. With reference to FIG. 3, there is shown a block diagram 300 of exemplary operations from 302A to 302I performed by the electronic device 102 or the circuitry 202.

At 302A, a data acquisition operation may be executed. In the data acquisition operation, the circuitry 202 may be configured to receive the plurality of responses 112 for the plurality of questions. The plurality of questions may be associated with one or more surveys related to one or more services/products provided by an organization. The one or more surveys may be conducted on the plurality of customers 110 and/or on general public to receive ratings (as the plurality of responses 112) for the one or more services provided by the organization. The one or more surveys may include the plurality of questions related to the one or more services and a question associated with the brand of the organization (or associated with the brand of the one or more services provided by the organization). The question associated with the brand may be a specific question for an overall rating of the brand. By way of example and not limitation, the question associated with the brand may be framed as “How likely are you going to recommend the brand to your known ones?” or “How will you rate the brand?”. Similarly, the question related to a service-category may be “whether you will recommend this service/product to other people?”.

The circuitry 202 may receive the plurality of responses 112 for the plurality of questions and a response for the question associated with the brand from the plurality of customers 110 via the plurality of customer devices 104. In some embodiments, the circuitry 202 may retrieve the plurality of responses 112 from the server 106. The circuitry 202 may send information about a particular survey to the server 106 and retrieve the plurality of responses 112 about the particular survey from the server 106. Each of the plurality of responses 112 may correspond to a rating value for a corresponding question of the plurality of questions. The rating values may be between a minimum rating value and a maximum rating value (both inclusive). The minimum rating value and a maximum rating value may be fixed values and may not be modified by the plurality of customers 110 and/or by the general public. By way of example and not limitation, if the minimum rating value is set at “0” and the maximum rating value is set at “10”, such that each of the plurality of responses 112 may be between “0” and “10”. In an embodiment, each response of the plurality of responses 112 may include a plurality of rating values for different questions of the plurality of questions, where each question and corresponding rating value in the response may be associated with different service category.

At 302B, a data filtration operation may be performed. In the data filtration operation, the circuitry 202 may be configured to filter the received plurality of responses 112. The plurality of responses 112 may be filtered by the application of the one or more filtering rules on the plurality of responses 112 to determine a first set of responses. The one or more filtering rules may pre-decided logics that may be applied on the plurality of responses 112 to determine the first set of responses for a first set of questions out of the plurality of questions asked in the one or more surveys. In an embodiment, a first filtering rule of the one or more filtering rules may be to filter out each response in which less than a threshold number of questions have been answered. By way of example and not limitation, if the one or more surveys include 10 questions combined of different service categories and the threshold number of questions is 4, then all the responses in which less than 4 questions have been answered or rated by the plurality of customers 110 (and/or by the general public) may be excluded to determine the first set of responses. In another embodiment, a second filtering rule of the one or more filtering rules may consider the responses of one or more verified customers only. A verified customer may be a customer of the organization whose identity has been verified by the organization or who has frequently used a service, or a product provided by the organization in recent past (say in last 1 year or in certain months). For example, as per the second filtering rule, the responses of the unregistered customers may be excluded. In an embodiment, the circuitry 202 may select the first set of responses from the plurality of responses 112, where the first set of responses may correspond to a particular product or service out of the multiple products/services covered in the one or more surveys. For example, in case the organization is a vehicle manufacture and the one or more surveys includes questions related to different four-wheeler vehicles and two-wheeler vehicles manufactured or sold by the organization, then the one or more filtering rules may indicate to select the first set of responses related to only four-wheelers vehicle and exclude responses where majority of questions related to the two-wheeler vehicles have been responded or rated by customers. In some embodiments, the responses of the customers who own a particular type of product (example a particular type or model of vehicle) may be selected within the first set of responses. In another example, responses of the customers located at a predefined location (like a particular ZIP code) may be selected within the first set of responses. In another example, responses related to the products or services sold or offered at a predefined location may be selected within the first set of responses. In yet another example, the one or more filtering rules may indicate to select the responses which may be received in a particular time duration. For example, the plurality of responses 112 received in last one month or received during last two surveys may be selected within the first set of responses. In yet another example, the one or more filtering rules may indicate to select the responses which may be received from a customer of a particular age. For example, the plurality of responses 112 received from the customers with age more than 18 years may be selected within the first set of responses. The circuitry 202 may be configured to determine the first set of responses based on the application of the one or more filtering rules on the plurality of responses 112. In other words, the circuitry 202 may determine the first set of responses based on the filtration of the received plurality of responses 112. It may be noted that a count of the plurality of responses 112 may be greater than (or equal to) a count of the first set of responses.

In an embodiment, the first set of responses may be for the first set of questions (i.e. subset) out of the plurality of questions that are related to the plurality of responses 112. The first set of questions may be associated with a first set of parameters (i.e. episodes) of a set of service categories related to the one or more services offered by the organization. The set of service categories may correspond to at least one of, but is not limited to, a dealer-related category, a customer experience-related category, an ambience-related category, a troubleshooting-related category (or a diagnostic-related category), a sales-related category, a finance-related category, a price-related category, a product-related category, a functionality-related category, an aesthetics-related category, or a hospitality-related-category. The set of service categories and the set of parameters may be preselected based on the services or products provided by the organization. In some embodiments, the set of service categories and the set of parameters may be selected based on life time journey of the plurality of customers 110 to experience or use different services/products of the organization. In an embodiment, the set of service categories and the corresponding set of parameters may be pre-defined by an executive of the organization, such as a marketing expert, a customer relationship manager, an owner, or a team lead of a particular operation/department of the organization.

For example, the first set of parameters associated with the dealer-related category or dealer-controlled category, may include, but is not limited to, a shopping parameter, an equipment test parameter, a price negotiation parameter, an ownership type parameter, an equipment warranty parameter, or a financing-related parameter. The circuitry 202 may be configured to determine the first set of responses for the first set of questions associated with each of the first set of parameters of the dealer-related category because an improvement in the rating values of the first set of parameters may lead to an improvement in the brand rating of the organization. Moreover, the first set of parameters associated with the dealer-related category may be dependent on the one or more dealers of the organization. The first set of responses related to the questions which are associated with the parameters of the dealer-related category may indicate different feedbacks or rating values provided by the customers to the dealer-related services.

By way of example and not limitation, for a vehicle brand, the shopping parameter of the first set of parameters may indicate the customer experience at a physical/online store or shop of the vehicle or any other product. The response related to the shopping parameter may indicate a rating value or feedback provided by the customer about his/her experience about the physical/online store during the shopping of the vehicle or any other product. The equipment test parameter of the first set of parameters may be related to customer's experience about the test drive of the vehicle during purchase. The response or question related to the equipment test parameter may indicate a rating value or feedback provided by the customer about his/her test driving experience, to the dealer. The price negotiation parameter of the first set of parameters may be related to the negotiations between the dealer and the customer for a final price of the vehicle during purchase. The response or question related to the price negotiation parameter may indicate a rating value or feedback provided by the customer about his/her price negotiation experience with the dealer. The ownership type parameter may indicate whether the customer has purchased the vehicle or leased the vehicle. The equipment warranty parameter may be related to extended warranty for the vehicle. The response or question related to the warranty parameter may indicate a rating value or feedback given by the customer about the warranty provided by the dealer on the purchase of the vehicle (or any other product). Similarly, the financing-related parameter may be related to the customer's experience about financing (i.e. insurance) options provided by the dealer during the purchase of the vehicle.

It may be noted that the first set of parameters and the service categories provided with respect to the dealers of the organization is merely an example. The service categories and the parameter (i.e. episodes) may be related to different types of services/products/departments (i.e. which interacts with the customers) of the organization in various fields or domains, without a deviation from the scope of the disclosure. Examples of such domains (or services) may include, but are not limited to, a banking domain, a telecommunication domain, a manufacturing domain, a customer-care domain, a product delivery domain, an entertainment domain, a supply-chain domain, a hotel/restaurant domain, an educational domain, a health-care domain, a beauty-care domain, a security/safety domain, a logistics domain, or a travel domain.

At 302C, an attribution score calculation operation may be performed. In the attribution score calculation operation, the circuitry 202 may be configured to calculate an attribution score for each of the first set of parameters based on the determined first set of responses. The attribution score may indicate an impact of the corresponding parameter on the brand associated with the one or more services. Specifically, the attribution score may indicate an impact of the corresponding parameter on the brand rating.

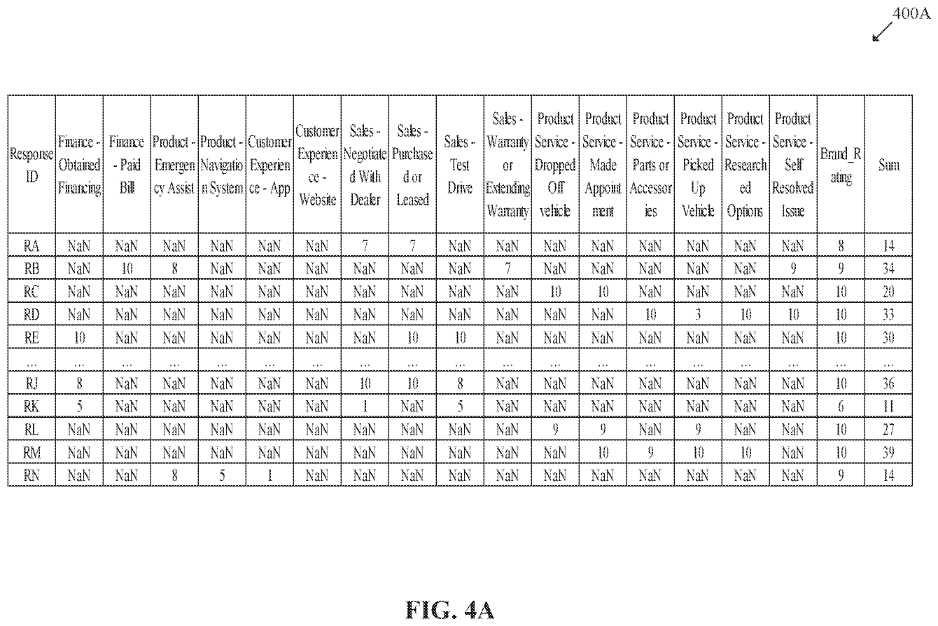

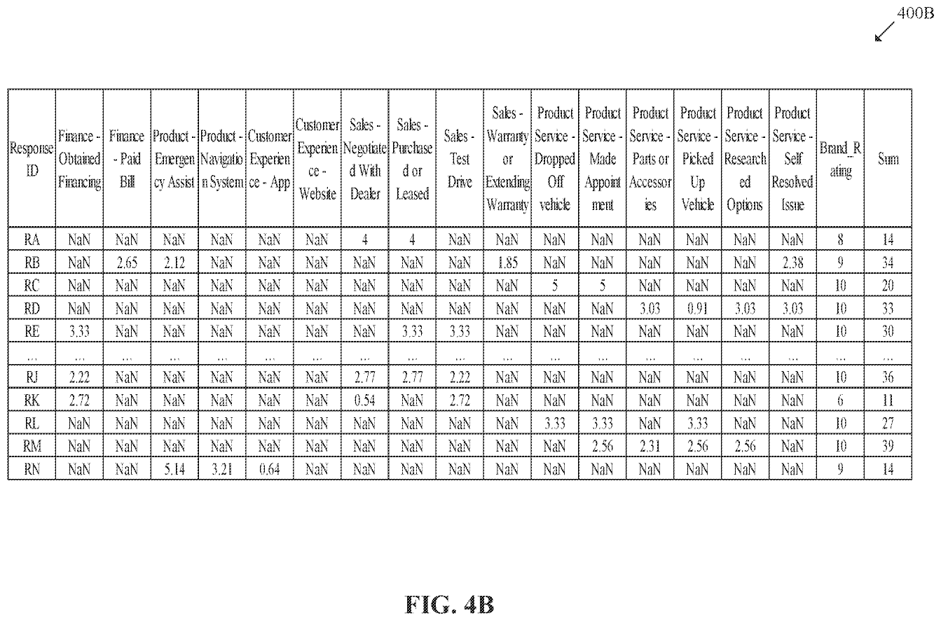

To calculate the attribution score, the circuitry 202 may be configured to determine the rating value from each of the first set of responses associated with the first set of parameters. Based on the determination of the rating value for each of the first set of parameters, the circuitry 202 may be configured to calculate a summation of the rating values associated with the first set of parameters for each of the first set of responses. For example, each response indicates a particular rating value (say between “0” to “10”) for different parameters of the set of service categories, then the attribution score for each parameter may be determined based on the summation of the rating values for different parameters for the corresponding response. Further, the circuitry 202 may further determine or extract a brand rating value from the response associated with the question related to the brand in the one or more surveys. The details about the attribution scores are provided, for example, in FIGS. 4A and 4B.

Based on the determined rating value for each of the first set of parameters, the determined brand rating value, and the calculated summation of the rating values, the circuitry 202 may be further configured to calculate the attribution score for each of the first set of parameters. By way of example, and not limitation, the calculation of the attribution score for each of the first set of parameters is given by equation (1), as follows:

$${( A . S . )}_{ij} = \frac{{( Rating Value )}_{ij}}{{( Summation of Rating Values )}_{j}} * {( brand rating value )}_{j} \qquad ( 1 )$$

Where, (A.S.)ᵢⱼ may represent the attribution score for i^{th} parameter in the j^{th} response, (Rating Value)ᵢⱼ may represent a rating value for i^{th} parameter in the j^{th} response, (Summation of Rating Values) may represent calculated summation of the rating values in the j^{th} response, and (brand rating value) may represent the brand rating value in the j^{th} response.

In light of equation (1), when a customer provides responses to more number of parameters (or episodes) or experienced more number of parameters identified in the survey, it may indicate a better perception of the customer towards the overall brand of the services or organization. Thus, more number of questions related to different parameters are answers or rated during the survey, higher may be customer's influence towards the brand of the organization, as different parameters may have corresponding impact on the brand of the organization. Further, as the brand rating value is directly proportional to the attribution score (as per equation (1)), the contribution of the brand rating value may be higher for the calculation of the attribution score for each parameter.

At 302D, a sample participant size determination operation may be performed. In the sample participant size determination operation, the circuitry 202 may be configured to determine a sample participant size of the one or more surveys. The sample participant size may correspond to a count of individual samples or observations in the one or more surveys. In other words, the sample participant size may indicate the number of individual samples measured or observations used in the one or more surveys for the analysis of each parameter in the sample of responses. In an embodiment, the sample participant size may be equal to a count of the first set of responses that may be used to calculate the attribution score, for example, at 302C. In another embodiment, the sample participant size may be different for each parameter, such that the number of responses (i.e. rating values) received for a particular parameter in the first set of responses may be considered as the sample participant size for the corresponding parameter, as further described for example, in FIG. 5.

At 302E, a normalized attribution score calculation operation may be performed. In the normalized attribution score calculation operation, the circuitry 202 may be configured to calculate a normalized attribution score for each of the first set of parameters based on the determined sample participant size and the calculated attribution score for each of the first set of parameters. Specifically, the circuitry 202 may be configured to calculate the summation of the attribution scores of each parameter in the first set of responses, and further calculate the normalized attribution score for each parameter based on the calculated summation of the attribution scores and the determined sample participant size for the corresponding parameter. The normalized attribution score may indicate the impact of the corresponding parameter on the brand associated with the one or more services. The details about the calculation of the normalized attribution score are provided, for example, in FIG. 5.

By way of example, and not limitation, the calculation of the normalized attribution score for each of the first set of parameters is given by equation (2), as follows:

$${( N . A . S . )}_{i} = \frac{{( Summation of Attribution Score )}_{i}}{S . P . S} \qquad ( 2 )$$

Where, (N.A.S.)ᵢ may represent the normalized attribution score for i^{th} parameter, (Summation of Attribution Score)ᵢ may represent the calculated summation of the attribution scores of the i^{th} parameter for the first set of responses of the one or more surveys, and S.P.S may represent the determined sample participant size of different parameter in the one or more surveys.

At 302F, an attribution percentage calculation operation may be performed. In the percentage calculation operation, the circuitry 202 may be configured to calculate an attribution percentage of each of the first set of parameters. The attribution percentage may indicate the impact of the corresponding parameter on the brand associated with the one or more services. To calculate the attribution percentage of each of the first set of parameters, the circuitry 202 may calculate a sum of normalized attribution scores calculated for the first set of parameters (for example described at 302E). Based on the calculation of the sum of the normalized attribution scores, the attribution percentage may be calculated based on the normalized attribution score of the corresponding parameter and the calculated sum of normalized attribution scores for the first set of parameters. The details about the calculation of the attribution percentage are provided, for example, in FIG. 5.

By way of example, and not limitation, the calculation of the attribution percentage for each of the first set of parameters is given by equation (3), as follows:

$${( A . P . )}_{i} = \frac{{( Normalized Attribution Score )}_{i}}{( Sum of Normalized Attribution Scores )} * 100 \qquad ( 3 )$$

Where, (A.P.)ᵢ may represent the attribution percentage for i^{th} parameter, (Normalized Attribution Score)ᵢ may represent the calculated normalized attribution score of the i^{th} parameter, and (Sum of Normalized Attribution Scores) may represent the summation of the attribution scores of each of the first set of parameters.

At 302G, a first parameter determination operation may be performed. In the first parameter determination operation, the circuitry 202 may be configured to determine a first parameter from the first set of parameters. The determined first parameter may be a parameter with a maximum attribution percentage among the attribution percentages calculated for the first set of parameters. The determined first parameter may be a most impactful or critical parameter for an enhancement of the brand (or the brand rating). In other words, the determined first parameter may be identified as the most impactful parameter from the analysis (for example performed at steps 302A-302F) of the plurality of responses 112 related to the one or more surveys. The determined first parameter may be related to a particular service provided by the organization. The brand of the organization may be enhanced in case the operations of the particular service (i.e. related to the most impact parameter) may be controlled or upgraded. Exemplary details of the determined first parameter are provided, for example, at FIG. 5.

At 302H, a first service control operation may be performed. In the first service control operation, the circuitry 202 may be configured to control a first service associated with the determined first parameter. The control of the first service may correspond to an execution of one or more operations, related to the first service, that impact a brand rating value of the brand associated with the organization. For example, the one or more operations may include, but are not limited to, a recommendation of one or more training sessions for one or more employees of the first service (such as dealership or any other department/service of the organization), a recommendation of one or more new hardware's or software's to be installed or upgraded associated with the first service, a recommendation to improve or upgrade a user interface, recommendation of procurement of one or more equipment's, a recommendation for hiring new employees, a recommendation to terminate problematic employees, a recommendation for enhancing ambience or infrastructure at a place related to the first service. In another example, the one or more operations may further include, but are not limited to, a recommendation for adding new financial deals or modification of existing financial deals, a recommendation to change operational plan (or a strategy plan, a marketing/sales plan) for the first service, or a recommendation to change the functionalities or aesthetics of a product related to the first service. The one or more operations, when executed for the first service, may increase the rating value for the first parameter or other associated parameter, in near future. The increment in the rating value for the first parameter (i.e. most impactful parameter) may ultimately lead to increments in the brand rating value (or overall NPS) for the organization or for a particular service provided by the organization.

FIG. 4A depicts an exemplary set of responses for a plurality of questions in the one or more surveys related to a vehicle brand, in accordance with an embodiment of the disclosure. FIG. 4A is explained in conjunction with elements from FIG. 1, FIG. 2, and FIG. 3. There is shown an exemplary table 400A that includes the first set of responses for the plurality of questions.

In an embodiment, for example, a vehicle brand or organization may provide one or more services. The one or more services may be related to a set of service categories. The set of service categories (i.e. related to the one or more services) which are provided by the vehicle organization may correspond to, but are not limited to, a dealer-related category, a customer experience-related category, an ambience-related category, a troubleshooting-related category, a sales-related category, a finance-related category, a price-related category, a product-related category, a product service-related category, a functionality-related category, an aesthetics-related category, or a hospitality-related-category.

By way of example and not limitation, as shown in Table 1 for the vehicle brand, the set of service categories (also referred as episodes categories) may include, the product service-related category (i.e. troubleshooting-related category), the finance-related category, the customer experience-related category, the product-related category, and the sales-related category. Each of the set of services categories may include a first set of parameters (also referred as episodes). For example, each of the set of service categories along with their corresponding first set of parameters are presented in Table 1, as follows:

TABLE 1
Examples of the Service Categories and corresponding
Parameters for the vehicle brand.

| Service Category | Parameter |
|---|---|
| Product Service (i.e. | Self-Resolved Issue |
| Troubleshooting) | Research Options |
| | Picked Up Vehicle |
| | Parts or Accessories |
| | Made Appointment |
| | Dropped off Vehicle |
| Sales (i.e. Purchase) - | Warranty or Extended Warranty (i.e. |
| Dealer-related/ | equipment warranty parameter) |
| controlled Category | Test Drive (i.e. equipment test parameter) |
| | Shopped for Vehicles (i.e. shopping parameter) |
| | Obtained Financing (i.e. Insurance) - |
| | financing-related parameter |
| | Purchased or Leased (i.e. ownership type |
| | parameter) |
| | Negotiated with Dealer (i.e. price negotiation |
| | parameter) |
| Customer Experience | Website |
| | Application (Apps) |
| Product (for example | Navigation System |
| In-Vehicle) | Entertainment |
| | Emergency Assist |
| Finance | Paid Bill |
| | Researched Models |

The plurality of questions asked in the one or more surveys may be related to each of the first set of parameters which may be associated with each of the six service categories presented, for example, in Table 1 for the organization of the vehicle. The circuitry 202 may be configured to receive the plurality of responses 112 for the plurality of questions related to the first set of parameters. As discussed above, each of the plurality of responses 112 may include a rating value for a corresponding question for a particular parameter and the rating value may be between the minimum rating value and the maximum rating value. The rating value may indicate a customer feedback about the corresponding parameter of different service categories.

With reference to the exemplary table 400A of FIG. 4A, a first column may indicate a serial number for the first set of responses. As depicted, there may be ‘N’ number of responses for the first set of questions associated with the one or more surveys. A second column may indicate a response identifier (ID) of the corresponding customer who have answered or provide rating values to the one or more surveys. The response ID may be a unique identifier of the corresponding customer or the corresponding response. The third column may be associated with the ‘Obtained Financing’ parameter of the ‘Finance’ service category. For example, as shown in Table 1, the customer with the response ID as ‘RA’ may not have provided a response or rating for the question related to the ‘Obtained Financing’ parameter of the ‘Finance’ service category and therefore, a value of corresponding cell may be ‘NaN’. In an embodiment, the customer with the response ID as ‘RA’ may not have provided a response for the question related to the ‘Obtained Financing’ parameter of the ‘Finance’ service category because the corresponding customer may not have obtained finance (i.e. insurance options) in his lifetime journey with the organization or may not have any experience related to ‘Obtained Financing’ parameter. Therefore, a cell value of ‘NaN’ in the exemplary table 400A may indicate that the corresponding customer may not have experienced the corresponding parameter with the organization or may have not provided the rating value or feedback while executing the corresponding survey.

With reference to the exemplary table 400A of FIG. 4A, a fourth column may be associated with the ‘Paid Bill’ parameter of the ‘Finance’ service category. A fifth column be associated with the ‘Emergency Assist’ parameter of the ‘Product’ service category. A sixth column may be associated with the ‘Entertainment’ parameter of the ‘Product’ service category. A seventh column may be associated with the ‘Navigation System’ parameter of the ‘Product’ service category. An eight column may be associated with the ‘App’ parameter of the ‘Customer Experience’ service category. A ninth column may be associated with the ‘Website’ parameter of the ‘Customer Experience’ service category. A tenth column may be associated with the ‘Negotiated with Dealer’ parameter of the ‘Sales’ service category. An eleventh column may be associated with the ‘Purchased or Leased’ parameter of the ‘Sales’ service category. A twelfth column may indicate that there may additional one or more columns between the eleventh column and a thirteenth column that are not shown in the exemplary table 400A. A thirteenth column may be associated with the ‘Test Drive’ parameter of the ‘Sales’ service category. A fourteenth column may be associated with the ‘Warranty or Extended Warranty’ parameter of the ‘Sales’ service category. A fifteenth column may be associated with the ‘Dropped off Vehicle’ parameter of the ‘Product Service’ service category. A sixteenth column may be associated with the ‘Made Appointment’ parameter of the ‘Product Service’ service category. A seventeenth column may be associated with the ‘Parts or Accessories’ parameter of the ‘Product Service’ category. An eighteenth column may be associated with the ‘Picked Up Vehicle’ parameter of the ‘Product Service’ service category. A nineteenth column may be associated with the ‘Researched options’ parameter of the ‘Product Service’ service category. A twentieth column may be associated with the ‘Self-Resolved Issue’ parameter of the ‘Product Service’ service category. A twenty-first column may be associated with the brand rating value that may be received in response to the question associated with the brand during the survey. In an embodiment, the twenty-second column in the table 400A may correspond to a sum of all the rating values of all the parameters in each of the service category and the brand rating value. The circuitry 202 may calculate the summation of the rating values for each parameter in each row (excluding the cell values ‘NaN’). The calculated summation of the rating values associated with the first set of parameters for each of the first set of responses is shown in the twenty-second column of the exemplary table 400A.

By way of example and not limitation, the customer with response ID ‘RE’ may have given a rating value of ‘10’ to each of a first question associated with the ‘Obtained Financing’ parameter of the ‘Finance’ service category, to a second question associated with the ‘Purchased or Leased’ parameter of the ‘Sales’ service category, to a third question associated with the ‘Test Drive’ parameter of the ‘Sales’ service category, and to the question associated with the brand. Therefore, the corresponding sum all the rating values may be ‘30’ as shown in the corresponding cell value. Similarly, the circuitry 202 may determine the rating values for each parameter from the first set of responses and further calculate the summation of the rating values associated with the first set of parameters for each of the first set of responses as shown, for example, in FIG. 4A.

FIG. 4B depicts exemplary attribution scores for each parameter related to the vehicle brand of FIG. 4A, in accordance with an embodiment of the disclosure. FIG. 4B is explained in conjunction with elements from FIG. 1, FIG. 2, FIG. 3, and FIG. 4A. With reference to FIG. 4B, there is shown an exemplary table 400B that includes the attribution scores for each of the first set of parameters included in each of the set of service categories, calculated based on the rating values as shown in the exemplary table of FIG. 4A.

Based on the reception or determination of the first set of responses for each of the first set of parameters associated with each of the set of service categories, the circuitry 202 may be configured to calculate an attribution score for each of the first set of parameters included in each of the set of service categories related to the one or more services (i.e. finance, troubleshooting, sales, product functionality, etc). The attribution score may indicate an impact of the corresponding parameter on the brand associated with the one or more services. To calculate the attribution score, the circuitry 202 may be configured to determine the rating value from each of the first set of responses associated with the first set of parameters and determine the brand rating value from the response associated with the question related to the vehicle brand (i.e. the twenty-first column of exemplary table 400A). The circuitry 202 may further determine the calculated sum of the rating values associated with each of the first set of parameters (i.e. sum from the twenty-second column of the exemplary table 400A) for the first set of responses. The circuitry 202 may further calculate the attribution score for each of the first set of parameters based on the determined rating value for the corresponding parameter, the determined brand rating value, and the determined summation of the rating values of the first set of parameters. The calculation of the attribution scores for the first set of parameters is provided in the equation (1) at 302C in FIG. 3.

By way of example and not limitation, as shown in FIG. 4B, the attribution score for the ‘Obtained Financing’ parameter of the ‘Finance’ service category, for the response ID ‘RE’, may be calculated as ((10/30)*10) that is equal to “3.33”. As another example, the attribution score for the ‘Negotiated with Dealer’ parameter of the ‘Sales’ service category, for the response ID ‘RK’, may be ((1/11)*6) that is equal to “0.54”. Similarly, as shown in FIG. 4B, the circuitry 202 may be configured to calculate the attribution score for each parameter of different service categories for each of the first set of responses, which are analyzed from the one or more surveys for the determination of most impactful parameter.

FIG. 5 depicts an exemplary normalized attribution score, and attribution percentage of each of a first set of parameters related to a vehicle brand, in accordance with an embodiment of the disclosure. FIG. 5 is explained in conjunction with elements from FIG. 1, FIG. 2, FIG. 3, FIG. 4A, and FIG. 4B. With reference to FIG. 5, there is shown an exemplary table 500. The exemplary table 500 may include a first column 502 that depicts each parameter of the first set of parameters for a particular brand (such as the vehicle brand), a second column 504 that indicates a summation of attribution scores of the corresponding parameter of all the first set of responses, a third column 506 that indicates a sample participant size of the corresponding parameter, a fourth column 508 that indicates a normalized attribution score of the corresponding parameter, and a fifth parameter 510 that indicates an attribution percentage of the corresponding parameter.

Based on the calculation of the attribution score of each parameter (as described, for example, in FIGS. 4A-4B), the circuitry 202 may be configured to calculate a normalized attribution score for each of the first set of parameters. To calculate the normalized attribution score, the circuitry 202 may be configured to determine the sample participant size for each parameter related to the corresponding question of the one or more surveys. The details about the determination of the sample participant size are provided, for example, in FIG. 3 (at 302D). The circuitry 202 may be further configured to calculate the normalized attribution score for each of the first set of parameters based on the determined sample participant size (i.e. third column 506) and the calculated sum of attribution scores (i.e. second column 504) for each of the first set of parameters. The details about the calculation of the normalized attribution score are provided, for example, in FIG. 3 (at equation (2) at 302E). As referred in FIG. 5, for example, the sample participant size for different parameters may be different. The sample participant size may indicate actual number of responses (i.e. rating values) received for a particular parameter in all of the first set of responses by the plurality of customers 110. As shown in FIG. 4A, the customer may not provide the rating value (or response) for a particular parameter related to a particular question, thus, such responses (with “NaN” value) may not be considered in the sample participant size for the calculation of the normalized attribution score for the corresponding parameter. For example, as shown in FIG. 5, in case for the parameter “Parts or Accessories”, the sample participant size is “352” and the sum of attribution scores is “1167.583”, then the circuitry 202 may calculate the normalized attribution score as “3.317” for the parameter “Parts or Accessories” of the ‘Product Service’ category.

Based on the calculation of the normalized attribution score, the circuitry 202 may be further configured to calculate an attribution percentage of each of the first set of parameters based on the normalized attribution score of the corresponding parameter and a sum of normalized attribution scores of the first set of parameters. The details of the calculation of the attribution percentage for each of the first set of parameters are provided, for example, in equation (3) in FIG. 3 (at 302F). By way of example and not limitation, the attribution percentage of the ‘Parts or Accessories’ parameter of the ‘Product Service’ service category, may be calculated as ((3.317/51.285)*100) that is equal to 6.468%. In such example, “51.285” is calculated sum of the normalized attribution scores for the first set of parameters as described, for example, in equation (3). As another example, the attribution percentage of the ‘Warranty or Extended Warranty’ parameter of the ‘Sales’ service category may be ((2.538/51.285)*100) that is equal to 4.949%. Similarly, as shown in FIG. 5, the circuitry 202 may determine the attribution percentage for each parameter of different service categories pre-defined for different services provided by the organization.

The circuitry 202 may be further configured to determine the first parameter from the first set of parameters. The determined first parameter may have a maximum attribution percentage among the attribution percentages calculated for the first set of parameters. With reference to the exemplary table 500, the determined first parameter for the dealer-related category or sales service category (i.e. described, for example, in FIG. 3 at 302B and Table 1) may be the Warranty or Extended Warranty' parameter with the attribution percentage as “4.949%” among other attribution percentages (i.e. “4.820%”, “4.807%”, “4.606%”, “4.489%”, “4.371%”) of other parameters (“Test Drive”, “Purchased or Leased”, “Shopped for Vehicles”, “Obtained Financing”, and “Negotiated with Dealer”, respectively) of the dealer-related category or sales service category (i.e. mentioned in Table 1). Therefore, the ‘Warranty or Extended Warranty’ parameter of the ‘Sales’ service (or the dealer related or controlled category) may be a most impactful or critical parameter for an enhancement of the brand. Similarly, the circuitry 202 may determine the first parameter (i.e. most impactful parameter) for each service category based on the comparison of the attribution percentages of each service category of the products or services provided by the organization. In an embodiment, the circuitry 202 may calculate the total attribution percentage for a particular service category. For example, the total attribution percentage for the dealer-related category or sales service category may be “28.04%” (i.e. sum of “4.949%”, “4.820%”, “4.807%”, “4.606%”, “4.489%”, and “4.371%)”). Thus, the total attribution percentage of each service category may allow to identify the contribution of each service category towards the brand rating of the organization. In an embodiment, the circuitry 202 may determine the most impactful parameter of all the service categories. For example, as shown in FIG. 5, the most impact parameter (i.e. first parameter) among parameters of all the service categories may be “Parts or Accessories” with highest attribution percentage, which further may have the capability to enhance the brand of the organization if operations related to the services of “Parts or Accessories” parameter are further controlled (or enhanced or optimized).

In an embodiment, based on the determination of the first parameter, the circuitry 202 may be configured to control a first service that may be associated with the determined first parameter. The control of the first service corresponds to an execution of one or more operations, related to the first service, that may impact a brand rating value of the brand associated with the organization. For example, if the determined first parameter (i.e. most impactful parameter) of the dealer-controlled category is “Warranty or Extended Warranty” parameter (as described, for example, in FIG. 5), then the circuitry 202 may control one or more operations related to warranty based service (i.e. first service associated with the “Warranty or Extended Warranty” parameter) provided by the dealer of the organization. The control of the one or more operation may include, but is not limited to, a recommendation to update the warranty policies, a recommendation to enhance number of years for warranty, or a recommendation to update return policies if warranty is violated, because the warranty-based parameter is determined as the most impactful parameter in the first set of responses received from the conducted survey for the brand of the organization. In another embodiment, the circuitry 202 may suggest different recommendations for different parameters (such as a least-important parameter or average-level parameter) of different service categories, such that the brand or the brand rating of the organization can be enhanced due to improvement in the operations of different services/products of the organization. Different examples of the control of the operations based on the determined first parameter are provided, for example, in FIG. 3 (at 302H).

It may be noted that the parameters (i.e. episodes), the set of service categories, the attribution scores, and attribution percentages shown in FIGS. 4A-4B and 5 related to the vehicle brand are merely examples. Different types of parameters and service categories may be applicable to different domains of the organization for the determination of the impactful parameter based the calculation of the attribution scores and the attribution percentages, without any deviation from the scope of the disclosure. Different examples of the domains of the organization and service are provided, for example, in FIG. 3.

In another embodiment, the organization may have more than one brand that may provide same types of services and/or equipment to the plurality of customers 110. For example, if the organization is a vehicle manufacturer, then the organization may sell or manufacture different vehicle models as different brands. In such a scenario, the disclosed electronic device 102 may be configured to compare the attribution percentages of the first set of parameters of each brand that provides the same service and/or equipment. This may assist the organization to understand how the attribution percentages of different parameters varies with different brands provided by the same organization.

By way of example and not limitation, the organization may have a first vehicle brand and a second vehicle brand. An exemplary experiment data observed for the first vehicle is presented in Table 2 (i.e. similar to FIG. 5), as follows:

TABLE 2
Exemplary Data for First Vehicle Brand under the Organization.

| | Sum of | Normalized | |
|---|---|---|---|
| | Attribution | Attribution | Attribution |
| Parameter | Score | Score | Percentage |
| Parts or Accessories | 1167.583 | 3.317 | 6.468 |
| Paid Bill | 1224.059 | 3.213 | 6.264 |
| Researched Models | 955.144 | 3.194 | 6.229 |
| Entertainment | 1128.229 | 2.953 | 5.759 |
| Dropped Off vehicle | 3810.445 | 2.952 | 5.755 |
| Researched Options | 808.049 | 2.845 | 5.548 |
| Emergency Assist | 1067.634 | 2.802 | 5.464 |
| Self-Resolved Issue | 707.933 | 2.787 | 5.435 |
| Picked Up Vehicle | 3240.133 | 2.744 | 5.35 |
| Made Appointment | 3139.507 | 2.706 | 5.277 |
| Website | 468.091 | 2.615 | 5.099 |
| Warranty or Extending | 449.206 | 2.538 | 4.949 |
| Warranty | | | |
| Test Drive | 620.459 | 2.472 | 4.82 |
| Navigation System | 643.786 | 2.467 | 4.81 |
| Purchased or Leased | 658.262 | 2.465 | 4.807 |
| Shopped For Vehicles | 536.227 | 2.362 | 4.606 |
| App | 350.926 | 2.309 | 4.502 |
| Obtained Financing | 566.302 | 2.302 | 4.489 |
| Negotiated With Dealer | 520.056 | 2.242 | 4.371 |

From Table 2, it may be observed that the determined first parameter is ‘Warranty or Extended Warranty’ parameter for the dealer-related/controlled service category to enhance the brand of the first vehicle. It should be noted that data provided in Table 2 may merely be taken as experimental data and may not be construed as limiting the present disclosure.

By way of example and not limitation, the organization may have the second vehicle brand, which may be different from the first vehicle brand. An exemplary experiment data observed for the second vehicle is presented in Table 3, as follows:

TABLE 3
Exemplary Data for Second Vehicle Brand under the Organization

| | Sum of | Normalized | |
|---|---|---|---|
| | Attribution | Attribution | Attribution |
| Parameter | Score | Score | Percentage |
| Paid Bill | 726.386 | 3.214 | 6.944 |
| Entertainment | 592.231 | 2.644 | 5.712 |
| Emergency Assist | 570.396 | 2.568 | 5.526 |
| Parts or Accessories | 503.223 | 2.542 | 5.491 |
| Dropped Off vehicle | 773.755 | 2.537 | 5.481 |
| Warranty or Extending | 187.552 | 2.501 | 5.402 |
| Warranty | | | |
| Researched Models | 522.389 | 2.488 | 5.374 |
| Made Appointment | 755.702 | 2.459 | 5.313 |
| Picked Up Vehicle | 737.702 | 2.419 | 5.225 |
| Researched Options | 461.223 | 2.415 | 5.217 |
| Self-Resolved Issue | 423.128 | 2.404 | 5.194 |
| Navigation System | 529.757 | 2.354 | 5.086 |
| App | 186.576 | 2.332 | 5.038 |
| Website | 342.503 | 2.299 | 4.996 |
| Purchased or Leased | 253.728 | 2.286 | 4.938 |
| Test Drive | 239.491 | 2.259 | 4.881 |
| Obtained Financing | 226.500 | 2.243 | 4.845 |
| Shopped For Vehicles | 226.160 | 2.196 | 4.744 |
| Negotiated With Dealer | 186.251 | 2.141 | 4.625 |

From Table 3, it may be observed that the determined first parameter is the ‘Warranty or Extended Warranty’ for the dealer-related service category to enhance the brand of the second vehicle. It should be noted that data provided in Table 3 may merely be taken as experimental data and may not be construed as limiting the present disclosure.

Therefore, as per Tables 2-3, the determined first parameter may be same for both the first vehicle brand and the second vehicle brand, but the attribution percentages of the same first parameter may be different for both the first vehicle brand and the second vehicle brand. Therefore, the electronic device 102 may be configured to control or recommend different operations/solutions for the ‘Sales’ service or dealer-related services associated with the Warranty or Extended Warranty' parameter for the enhancements of the brands of the first vehicle and/or the second vehicle. Different controlled or recommended solutions/operations may improve the responses (or the rating values) provided by the plurality of customers 110 in future surveys such that the brand (i.e. the brand rating or an overall net promoter score (NPS) score) for the organization (or brand for the provided services) may be improved. Further, based on the improvement of the overall NPS score or brand rating, an overall lifetime journey or experience of the customers with the services/products of the organization may be enhanced.

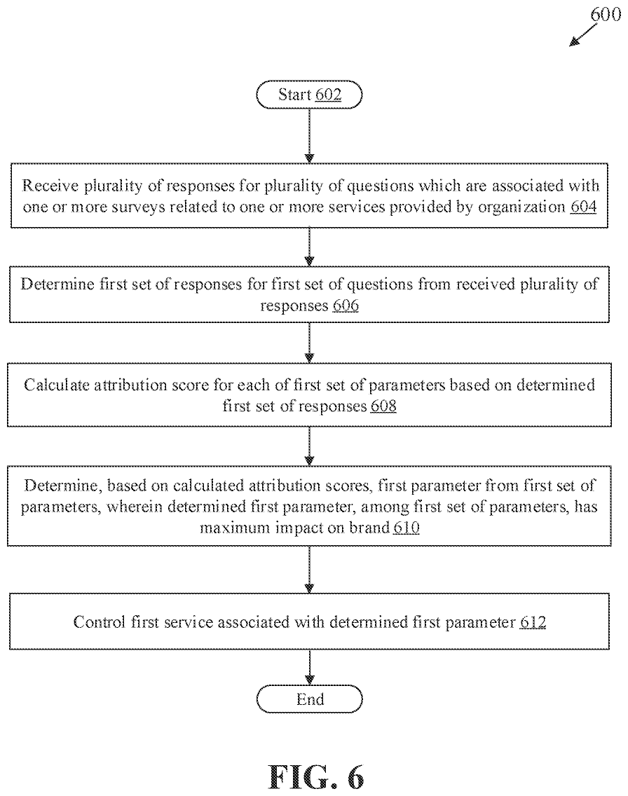

FIG. 6 is a flowchart that illustrates exemplary operations for impactful parameter determination for brand enhancement, in accordance with an embodiment of the disclosure. With reference to FIG. 6, there is shown a flowchart 600. The flowchart 600 is described in conjunction with FIGS. 1, 2, 3, 4A, 4B, and 5. The operations from 602 to 612 may be implemented, for example, by the electronic device 102 of FIG. 2 or the circuitry 202 of FIG. 2. The operations of the flowchart 600 may start at 602 and proceed to 604.

At 604, the plurality of responses 112 for the plurality of questions may be received. The plurality of questions may be associated with the one or more surveys related to the one or more services provided by the organization. In accordance with an embodiment, the electronic device 102 or the circuitry 202 may be configured to receive the plurality of responses 112 for the plurality of questions which may be associated with the one or more surveys related to the one or more services provided by the organization as described, for example, in FIGS. 1 and 3 (at 302A).

At 606, the first set of responses for a first set of questions from the received plurality of responses 112 may be determined. The first set of questions may be associated with the first set of parameters of the set of service categories related to the one or more services. In accordance with an embodiment, the electronic device 102 or the circuitry 202 may be configured to determine the first set of responses for the first set of questions from the received plurality of responses, wherein the first set of questions may be associated with the first set of parameters of the set of service categories related to the one or more services as described, for example, in FIG. 3 (at 302B).

At 608, an attribution score for each of the first set of parameters may be calculated. The attribution score may be calculated based on the determined first set of responses. The attribution score may indicate the impact of the corresponding parameter on the brand associated with the one or more services. In accordance with an embodiment, the electronic device 102 or the circuitry 202 may be configured to calculate the attribution score for each of the first set of parameters based on the determined first set of responses, as described, for example, in FIG. 3 (at 302C), FIG. 4A, and FIG. 4B.

At 610, a first parameter from the first set of parameters may be determined. The first set of parameters may be determined based on the calculated attribution scores and may be among the first set of parameters. The first parameter may have the maximum impact on the brand. In accordance with an embodiment, the electronic device 102 or the circuitry 202 may be configured to determine the first parameter from the first set of parameters based on the calculated attribution scores. The details about the determination of the first parameter are provided, for example, in FIG. 1, FIG. 3 (at 302G), FIG. 4A, FIG. 4B and FIG. 5.

At 612, the first service associated with the determined first parameter may be controlled. In accordance with an embodiment, the electronic device 102 or the circuitry 202 may be configured to controls the first service associated with the determined first parameter, as described, for example, in FIG. 3 (at 302H) and FIG. 5.

Various embodiments of the disclosure may provide a non-transitory, computer-readable medium and/or storage medium, and/or a non-transitory machine readable medium and/or storage medium stored thereon, a set of instructions executable by a machine and/or a computer (such as the electronic device 102) for impactful parameter determination for brand enhancement. The set of instructions may be executable by the machine and/or the computer to perform operations that may include receiving the plurality of responses 112 for a plurality of questions which are associated with one or more surveys related to one or more services provided by the organization. The operations may further include determining a first set of responses for a first set of questions from the received plurality of response. The first set of questions may be associated with a first set of parameters of a set of service categories related to the one or more services. The operations may further include calculating an attribution score for each of the first set of parameters based on the determined first set of responses. The attribution score may indicate an impact of the corresponding parameter on a brand associated with the one or more services. The operations may further include determining a first parameter from the first set of parameters based on the calculated attribution scores. The determined first parameter, among the first set of parameters, may have a maximum impact on the brand. The operations may further include controlling a first service associated with the determined first parameter.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

What is claimed is:

1. An electronic device, comprising:
circuitry which:
receives a plurality of responses for a plurality of questions which are associated with one or more surveys related to one or more services provided by an organization;
determines a first set of responses for a first set of questions from the received plurality of responses, wherein the first set of questions are associated with a first set of parameters of a set of service categories related to the one or more services;
calculates an attribution score for each of the first set of parameters based on the determined first set of responses, wherein the attribution score indicates an impact of the corresponding parameter on a brand associated with the one or more services;
determines, based on the calculated attribution scores, a first parameter from the first set of parameters, wherein the determined first parameter, among the first set of parameters, has a maximum impact on the brand; and
controls a first service associated with the determined first parameter.

2. The electronic device according to claim 1, wherein the one or more surveys comprise the first set of questions associated with the first set of parameters and a question associated with the brand.

3. The electronic device according to claim 1, wherein the circuitry further:
filters the received plurality of responses based on one or more filtering rules; and
determines the first set of responses based on the filtration of the received plurality of responses.

4. The electronic device according to claim 1, wherein each of the first set of responses comprises a rating value for a corresponding question of the first set of questions, and wherein the rating value is between a minimum rating value and a maximum rating value.

5. The electronic device according to claim 1, wherein the circuitry further:
determines a rating value from each of the first set of responses associated with the first set of parameters;
calculates a summation of the rating values of the first set of responses associated with the first set of parameters; and
calculates the attribution score for each of the first set of parameters based on the determined rating value for the corresponding parameter and the calculated summation of the rating values for the first set of parameters.

6. The electronic device according to claim 5, wherein the circuitry further:
determines a brand rating value from a response associated with a question related to the brand; and
calculates the attribution score for each of the first set of parameters further based on the determined brand rating value.

7. The electronic device according to claim 1, wherein the circuitry further:
determines a sample participant size of the one or more surveys; and
calculates a normalized attribution score for each of the first set of parameters based on the determined sample participant size and the calculated attribution score for each of the first set of parameters.

8. The electronic device according to claim 7, wherein the circuitry further:
calculates an attribution percentage of each of the first set of parameters based on the normalized attribution score of the corresponding parameter and a sum of normalized attribution scores for the first set of parameters; and
determines the first parameter from the first set of parameters, wherein the determined first parameter has a maximum attribution percentage among the attribution percentages calculated for the first set of parameters.

9. The electronic device according to claim 1, wherein the control of the first service corresponds to an execution of one or more operations, related to the first service, that impact a brand rating value of the brand associated with the organization.

10. The electronic device according to claim 1, wherein the set of service categories correspond to at least one of: a dealer-related category, a customer experience-related category, an ambience-related category, a troubleshooting-related category, a sales-related category, a finance-related category, a price-related category, a product-related category, a functionality-related category, an aesthetics-related category, or a hospitality-related-category.

11. The electronic device according to claim 10, wherein the first set of parameters associated with the dealer-related category comprise at least of a shopping parameter, an equipment test parameter, a price negotiation parameter, an ownership type parameter, an equipment warranty parameter, or a financing-related parameter.

12. A method, comprising:
in an electronic device:
receiving a plurality of responses for a plurality of questions which are associated with one or more surveys related to one or more services provided by an organization;
determining a first set of responses for a first set of questions from the received plurality of responses, wherein the first set of questions are associated with a first set of parameters of a set of service categories related to the one or more services;
calculating an attribution score for each of the first set of parameters based on the determined first set of responses, wherein the attribution score indicates an impact of the corresponding parameter on a brand associated with the one or more services;
determining, based on the calculated attribution scores, a first parameter from the first set of parameters, wherein the determined first parameter, among the first set of parameters, has a maximum impact on the brand; and
controlling a first service associated with the determined first parameter.

13. The method according to claim 12, wherein the one or more surveys comprise the first set of questions associated with the first set of parameters and a question associated with the brand.

14. The method according to claim 12, further comprising:
determining a rating value from each of the first set of responses associated with the first set of parameters;
calculating a summation of the rating values of the first set of responses associated with the first set of parameters; and
calculating the attribution score for each of the first set of parameters based on the determined rating value for the corresponding parameter and the calculated summation of the rating values for the first set of parameters.

15. The method according to claim 14, further comprising:
determining a brand rating value from a response associated with a question related to the brand; and
calculating the attribution score for each of the first set of parameters further based on the determined brand rating value.

16. The method according to claim 12, further comprising:
determining a sample participant size of the one or more surveys; and
calculating a normalized attribution score for each of the first set of parameters based on the determined sample participant size and the calculated attribution score for each of the first set of parameters.

17. The method according to claim 16, further comprising:
calculating an attribution percentage of each of the first set of parameters based on the normalized attribution score of the corresponding parameter and a sum of normalized attribution scores for the first set of parameters; and
determining the first parameter from the first set of parameters, wherein the determined first parameter has a maximum attribution percentage among the attribution percentages calculated for the first set of parameters.

18. The method according to claim 12, wherein the control of the first service corresponds to an execution of one or more operations, related to the first service, that impact a brand rating value of the brand associated with the organization.

19. A non-transitory computer-readable storage medium configured to store instructions that, in response to being executed, causes an electronic device to perform operations, the operations comprising:
receiving a plurality of responses for a plurality of questions which are associated with one or more surveys related to one or more services provided by an organization;
determining a first set of responses for a first set of questions from the received plurality of responses, wherein the first set of questions are associated with a first set of parameters of a set of service categories related to the one or more services;
calculating an attribution score for each of the first set of parameters based on the determined first set of responses, wherein the attribution score indicates an impact of the corresponding parameter on a brand associated with the one or more services;
determining, based on the calculated attribution scores, a first parameter from the first set of parameters, wherein the determined first parameter, among the first set of parameters, has a maximum impact on the brand; and
controlling a first service associated with the determined first parameter.

20. The computer-readable storage medium according to claim 19, wherein the control of the first service corresponds to an execution of one or more operations, related to the first service, that impact a brand rating value of the brand associated with the organization.
